(19) United States
(12) Patent Application Publication
(10) Pub. No.: US 2020/0101634 A1
(43) Pub. Date: Apr. 2, 2020

(54) TRIMMER AND TRIMMING METHOD

(71) Applicant: Horizon International Inc., Shiga (JP)

(72) Inventors: Satoshi TSUNAWAKI, Shiga (JP); Osamu NISHIMURA, Shiga (JP); Kazuyuki FUKUSHIMA, Shiga (JP)

(21) Appl. No.: 16/546,410

(22) Filed: Aug. 21, 2019

(30) Foreign Application Priority Data
Sep. 27, 2018 (JP) 2018-182216

(51) Int. Cl. B26D 5/02; B26D 7/02; B26D 1/08

(52) U.S. Cl. CPC B26D 5/02; B26D 2007/0081; B26D 1/08; B26D 7/025

(57) ABSTRACT

A trimmer trims a bound material at end portions and/or corner portions of the bound material. The trimmer has a table (2), a pressing unit (4), a trimming mechanism (5) that has a trimming blade (52) and moves the trimming blade (52) to the trimming position, a rotation mechanism (3) that rotates the table (2), a rotation control unit that is operatively connected to the rotation mechanism (3) in such a way that a predetermined trimming line of the bound material positioned parallel to a longitudinal direction of the trimming blade (52), a moving mechanism (6) that moves the trimming mechanism (5) in a direction perpendicular to the longitudinal direction of the trimming blade (52), and a movement control unit that is operatively connected to the moving mechanism (6) so as to move the trimming mechanism and align the trimming line and the trimming position with each other.

### TECHNICAL FIELD

The present invention relates to trimmers and trimming methods for use in bookbinding.

### BACKGROUND ART

Bookbinding includes the step of trimming top-edge, bottom-edge, and fore-edge portions of a bound material. An example of a trimmer used in the trimming step is a three-side trimmer disclosed in Japanese Laid-Open Patent Publication No. 2011-140080. This three-side trimmer includes a base plate, a trimming plate attached to the base plate, a pair of top and bottom blades for trimming the top-edge and bottom-edge portions of bound materials, and a fore-edge blade for trimming the fore-edge portion of the bound materials. In the three-side trimmer, bound materials are transported onto the trimming plate and then aligned with one another at the fore-edge portion, the top-edge portion, and the bottom-edge portion before being trimmed at the top-edge, bottom-edge, and fore-edge portions by the top and bottom blades and the fore-edge blade.

Another example of a trimmer used in the trimming step is a three-side trimmer disclosed in Japanese Laid-Open Patent Publication No. 2005-095994. This three-side trimmer includes a table, a pressing plate, and a trimming blade. In the three-side trimmer, a bound material is placed on the table, fixed by the pressing plate, and trimmed at the top-edge, bottom-edge, and fore-edge portions by the trimming blade with the table being rotated by 90 degrees at a time.

Incidentally, from the perspective of bound material design, there is some demand to trim the bound material in the form of a polygon other than a conventional rectangular shape, for example, in the form of a hexagon, by trimming corner portions adjacent to the fore edge. However, the three-side trimmers disclosed in Japanese Laid-Open Patent Publication Nos. 2011-140080 and 2005-095994 do not take account of such demand. Moreover, when the corners of a bound material are sharp, there is a safety issue in that the reader might be hurt by accidentally touching the corners with a part of the body. In this case, there is also a convenience issue in that the bound material is susceptible to bending at the corner portions.

### SUMMARY OF INVENTION

### Technical Problem

Therefore, a problem to be solved by the present invention is to provide a trimmer and a trimming method, both of which render it possible to form a bound material superior in design and free from safety and convenience issues.

### Solution to Problem

To solve the above problem, the present invention provides a trimmer which renders it possible to trim edge portions and corner portions of a bound material. The trimmer includes a table on which a bound material is to be placed, a pressing unit that is configured to fix the bound material on the table, and a rotation mechanism that is configured to rotate the table. The trimmer further includes a rotation control unit, a moving mechanism, and a movement control unit. The trimming mechanism has a trimming blade and is configured to move the trimming blade between a trimming position and a non-trimming position so as to trim an edge portion and/or a corner portion of the bound material. The rotation control unit is operatively connected to the rotation mechanism so as to rotate the table in such a way that a predetermined trimming line is parallel to a longitudinal direction of the trimming blade. The predetermined trimming line is set for the edge portion and/or the corner portion of the bound material. The moving mechanism is configured to move the table or the trimming mechanism in a direction perpendicular to the longitudinal direction of the trimming blade. The movement control unit operatively connected to the moving mechanism so as to move the table or the trimming mechanism in such a way that the trimming line and the trimming position are aligned with each other.

According to a preferred embodiment of the trimmer, the trimmer may further include a distance calculation unit, and a rotation angle calculation unit. The distance calculation unit calculates a distance between the trimming line and a predetermined rotation center of the bound material based on coordinates of both ends of the trimming line and coordinates of the rotation center of the bound material. The rotation angle calculation unit calculates a rotation angle of the table based on the coordinates of both ends of the trimming line in such a way that the trimming line is parallel to the longitudinal direction of the trimming blade. The bound material is placed on the table in such a way that the rotation center of the bound material is positioned on a rotation center of the table. And, the rotation control unit rotates the table by the rotation angle, the rotation angle being calculated by the rotation angle calculation unit. And, the movement control unit moves the table or the trimming mechanism in such a way that a distance between the rotation center of the bound material and the trimming position matches the distance calculated by the distance calculation unit.

According to another preferred embodiment of the trimmer, the trimmer may further include a first input unit. The first input unit receives an input of the coordinates of both ends of the trimming line.

According to a further preferred embodiment of the trimmer, the trimmer may further include a second input unit, and a coordinate determining unit. The second input unit receives an input of lengths of a pair of adjacent sides of the corner portion to be trimmed. The coordinate determining unit determines the coordinates of both ends of the trimming line of the corner portion to be trimmed, based on the lengths inputted to the second input unit.

According to a further preferred embodiment of the trimmer, the trimmer may further include a third input unit, and a fourth input unit. The third input unit receives an input of a predetermined rotation angle of the table in such a manner that the trimming line is parallel to the longitudinal direction of the trimming blade. The fourth input unit receives an input of a distance between a predetermined rotation center of the bound material and the trimming position. The bound material is placed on the table in such a way that the rotation center of the bound material is positioned on a rotation center of the table. And, the rotation control unit rotates the table by the rotation angle inputted to the third input unit. And, the movement control unit moves the table or the trimming mechanism such that the distance between the rotation center of the bound material and the trimming position matches the distance inputted to the fourth input unit.

To solve the above problem, the present invention provides a trimming method which renders it possible to trim a bound material at edge portions and corner portions. The method for trimming the bound material includes: (a) providing a trimmer for trimming the bound material; the trimmer including a table on which the bound material is to be placed, a pressing unit fixing the bound material on the table, a trimming mechanism having a trimming blade and moving the trimming blade between a trimming position and a non-trimming position so as to trim the bound material along a trimming line of the bound material, a rotation mechanism rotating the table, a moving mechanism moving the table or the trimming mechanism in a direction perpendicular to a longitudinal direction of the trimming blade, a rotation control unit operatively connected to the rotation mechanism, and a movement control unit operatively connected to the moving mechanism; (b) setting the trimming line for an edge portion and/or a corner portion of the bound material; (c) fixing the bound material on the table; (d) rotating the table in such a way that the trimming line is positioned parallel to the longitudinal direction of the trimming blade; (e) moving the table or the trimming mechanism so as to align the trimming line and the trimming position with each other; and (f) trimming the edge portion and/or the corner portion of the bound material along the trimming line.

According to a preferred embodiment of the trimming method, the trimmer may further include a rotation angle calculation unit calculating a rotation angle of the table. And, the method may further include (g) fixing the bound material on the table so as to position a predetermined rotation center of the bound material on a rotation center of the table, in step (c), (h) calculating the rotation angle of the table based on coordinates of both ends of the trimming line in such a way that the trimming line is parallel to the longitudinal direction of the trimming blade, after step (a) and before step (d), and (i) rotating the table by the calculated rotation angle, in step (d).

According to another preferred embodiment of the trimming method, the trimmer may further include a first input unit receiving an input of the coordinates of both ends of the trimming line. And, the method may further include (j) inputting the coordinates of both ends of the trimming line, after step (a) and before step (h).

According to a further preferred embodiment of the trimming method, the trimmer may further include a second input unit receiving an input of lengths of a pair of adjacent sides of the corner portion to be trimmed, and a coordinate determining unit determining the coordinates of both ends of the trimming line of the corner portion to be trimmed. And, the method may further include (k) inputting lengths of the pair of the adjacent sides of the corner portion to be trimmed, after step (a) and before step (h), and (l) determining the coordinates of both ends of the trimming line of the corner portion to be trimmed based on the inputted lengths of the pair of adjacent sides of the corner portion, after step (a) and before step (h).

According to a further preferred embodiment of the trimming method, the trimmer may further include a distance calculation unit calculating a distance between the trimming line and a predetermined rotation center of the bound material. And, the method may further include (m) fixing the bound material on the table so as to position the rotation center of the bound material on a rotation center of the table, in step (C), (n) calculating the distance between the trimming line and the rotation center of the bound material based on coordinates of both ends of the trimming line and coordinates of the rotation center of the bound material after step (a) and before step (e), and (o) moving the table or the trimming mechanism so that the distance between the rotation center of the bound material and the trimming position matches the calculated distance, in step (e).

According to a further preferred embodiment of the trimming method, the trimmer may further include a first input unit receiving an input of the coordinates of both ends of the trimming line. And, the method may further include (p) inputting the coordinates of both ends of the trimming line after step (a) and before step (n).

According to a further preferred embodiment of the trimming method, the trimmer may further include a second input unit receiving an input of lengths of a pair of adjacent sides of the corner portion to be trimmed, and a coordinate determining unit determining the coordinates of both ends of the trimming line of the corner portion to be trimmed. And, the method may further include (q) inputting of lengths of the pair of adjacent sides of the corner portion to be trimmed, after step (a) and before step (n), and (r) determining the coordinates of both ends of the trimming line of the corner portion to be trimmed based on the inputted lengths of the pair of adjacent sides of the corner portion, after step (a) and before step (n).

According to a further preferred embodiment of the trimming method, the trimmer may further include a third input unit receiving an input of a predetermined rotation angle of the table. And, the method may further include (s) fixing the bound material on the table so as to position a predetermined rotation center of the bound material on a rotation center of the table, in step (C), (t) inputting the rotation angle of the table in such a way that the trimming line is parallel to the longitudinal direction of the trimming blade, after step (a) and before step (d), and (u) rotating the table by the inputted rotation angle, in step (d).

According to a further preferred embodiment of the trimming method, the trimmer may further include a fourth input unit receiving an input of a distance between a predetermined rotation center of the bound material and the trimming position. And, the method may further include (v) fixing the bound material on the table so as to position the rotation center of the bound material on a rotation center of the table, in step (C), (w) inputting the distance between the rotation center of the bound material and the trimming position, after step (a) and before step (e), and (x) moving the table or the trimming mechanism so that the distance between the rotation center of the bound material and the trimming position matches the inputted distance, in step (e).

### Advantageous Effects of Invention

The trimmer and the trimming method according to the present invention render it possible to form a bound material superior in design and free from safety and convenience issues.

### BRIEF DESCRIPTION OF DRAWINGS

FIG. 1 is an outline diagram illustrating the flow of bound materials within a trimmer according to an embodiment of the present invention.

FIG. 2 is an oblique view schematically illustrating the configuration of a trimming section in FIG. 1.

FIG. 3A is a schematic diagram illustrating an input screen of the touch panel in FIG. 2.

FIG. 3B is a schematic diagram illustrating another input screen of the touch panel in FIG. 2.

FIG. 4 is a schematic diagram illustrating yet another input screen of the touch panel in FIG. 2.

FIG. 5 is a functional block diagram of a control unit in FIG. 2.

FIG. 6 is a schematic top view illustrating edge portions of a bound material to be trimmed.

FIG. 7A is a schematic top view illustrating a series of operations by the trimming section in the three-side trimming mode.

FIG. 7B is a schematic top view illustrating a series of operations by the trimming section in the three-side trimming mode and the corner trimming mode.

FIG. 8 is a schematic top view illustrating corner portions of a bound material to be trimmed.

### DESCRIPTION OF EMBODIMENTS

Hereinafter, an embodiment of the present invention will be described with reference to the accompanying drawings.

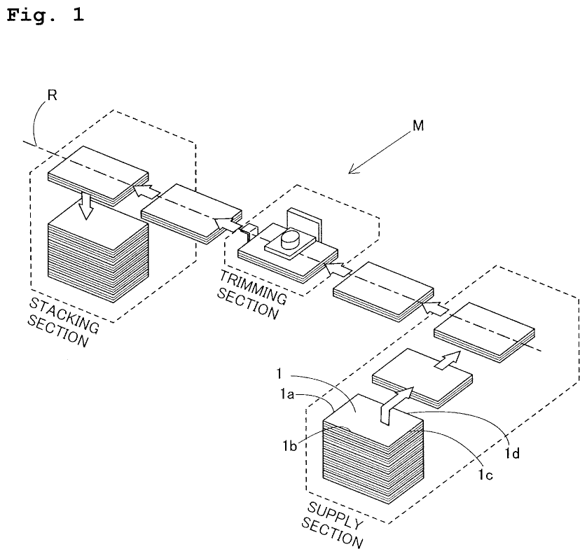

FIG. 1 is an outline diagram illustrating the flow of bound materials 1 placed within a trimmer M according to the embodiment. The trimmer M includes a supply section, a trimming section, and a stacking section. Initially, bound materials 1 placed in the supply section are sequentially supplied to a transportation path R by a supply device (not shown). Then, the bound material 1 is transported to the trimming section along the transportation path R and trimmed at edge portions and/or corner portions by the trimming section. Thereafter, the trimmed bound material 1 is further transported to the stacking section along the transportation path R and placed in the stacking section. The trimmer M has a three-side trimming mode and a corner trimming mode. In the three-side trimming mode, the bound material 1 is trimmed at a top-edge portion 1a, a fore-edge portion 1b, and a bottom-edge portion 1c. In the corner trimming mode, the bound material 1 is trimmed at a corner portion 1e, which includes a corner of the top-edge and fore-edge portions, and at a corner portion 1f, which includes a corner of the bottom-edge and fore-edge portions. The trimmer M operates simply in either mode or continuously in both modes.

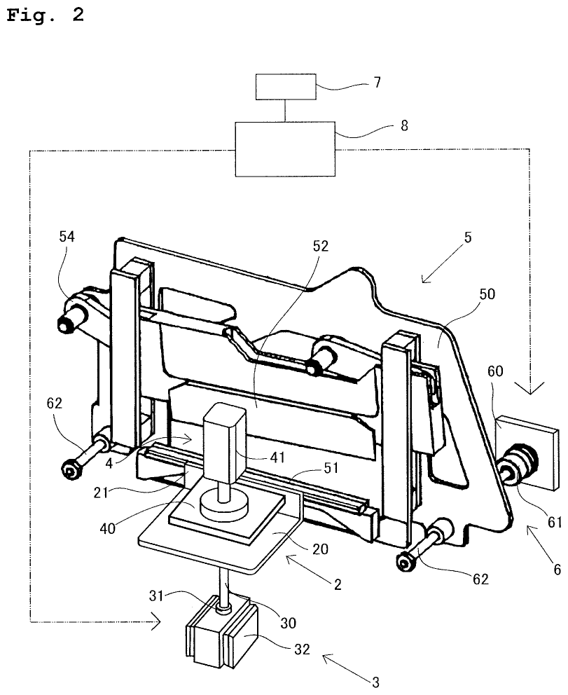

The trimming section includes a table 2, a rotation mechanism 3, a pressing unit 4, a trimming mechanism 5, a moving mechanism 6, a touch panel 7, and a control unit 8, as shown in FIG. 2.

The bound material 1 is transported to the table 2 and placed thereon. The table 2 has a table top 20 on which the bound material 1 is to be placed and an abutment portion 21. The abutment portion 21 is continuously erected from an edge of the table top 20. The bound material 1 is aligned by an alignment mechanism (not shown) such that a predetermined rotation center O of the bound material 1 is positioned on a rotation center of the table top 20, with a spine 1d contacting the abutment portion 21.

The rotation mechanism 3 is configured to rotate the table 2. The rotation mechanism 3 has a rotation shaft 30, which extends vertically so as to be connected to a bottom surface of the table 2, a bearing 31, which supports the rotation shaft 30, and a first motor 32, which is configured to rotate the rotation shaft 30.

The pressing unit 4 is configured to fix the aligned bound material 1 on the table top 20. The pressing unit 4 has a pressing plate 40, which is rotatably disposed directly above the rotation center O of the table 2 (i.e., above the rotation shaft 30), and a pressing plate lifting unit 41, which is connected to a top surface of the pressing plate 40. The pressing plate lifting unit 41 may be, for example, an air cylinder. The pressing unit 4 lowers the pressing plate 40 by means of the pressing plate lifting unit 41 so as to press a top surface of the bound material 1 placed on the table 2 by means of a bottom surface of the pressing plate 40, thereby fixing the bound material 1 on the table top 20.

The trimming mechanism 5 has a frame 50, a receiving portion 51, a securing plate (not shown), a securing plate lifting unit (not shown), a trimming blade 52, and a drive mechanism 54. The receiving portion 51 is connected to the frame 50 so as to be positioned below a trimming position for the trimming blade 52. The securing plate is connected to the securing plate lifting unit. The securing plate is configured to be moved by an ascending/descending operation of the securing plate lifting unit between a clamping position in which to clamp the bound material 1 on the receiving portion 51 and a non-clamping position away from the bound material 1. The trimming blade 52 is connected to the drive mechanism 54. The drive mechanism 54 is connected to the frame 50 so as to be able to swing the trimming blade 52 down. The trimming blade 52 is configured to be moved by the swinging operation of the drive mechanism 54 between a trimming position in which to trim the bound material 1 and a non-trimming position away from the bound material 1. When the bound material 1 being trimmed, initially, the securing plate lifting unit moves the securing plate to the clamping position, thereby clamping the bound material 1 with the securing plate. Then, the drive mechanism 54 moves the trimming blade 52 to the trimming position where the trimming blade 52 trims the bound material 1 along a predetermined trimming line (simply referred to below as a “trimming line”) CL set for an edge portion and/or a corner portion. The strength with which the securing plate lifting unit clamps the bound material 1 by the securing plate may be adjusted based on any or all of the following: the area to be clamped (specifically, the contact area of the securing plate with the bound material 1); the thickness of the bound material 1; the quality of paper used in the bound material 1; and the thickness of paper used in the bound material 1.

The moving mechanism 6 has a base 60, a second motor 61 connected to the base 60, and a feed screw 62 rotatably connected to the second motor 61. The feed screw 62 is in engagement with the frame 50. When the feed screw 62 is rotated by the second motor 61, the trimming mechanism 5 moves closer to or away from the table 2 in a direction perpendicular to the longitudinal direction of the trimming blade 52.

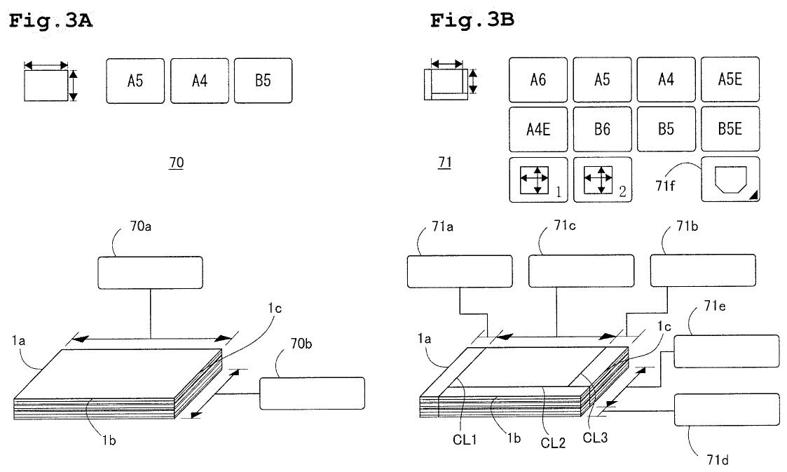

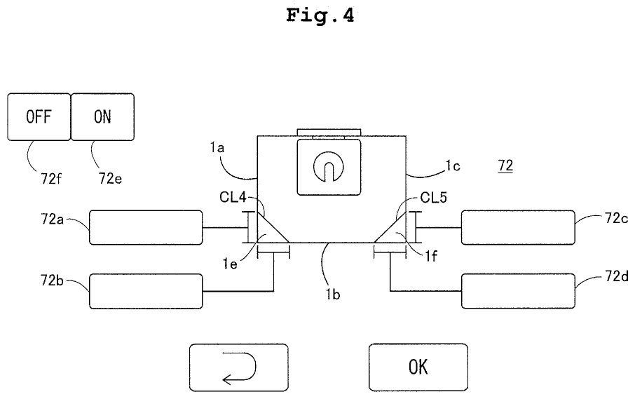

The touch panel 7 displays input screens 70, 71, and 72 in which dimensions of the bound material 1 before and after trimming, etc., can be directly inputted, as shown in FIGS. 3 and 4. The operator uses the touch panel 7 to input the dimensions of the bound material 1 before and after trimming, etc. The inputted dimensions are outputted to the control unit 8 to be described later.

With the input screen 70 shown in FIG. 3A, the length and width of the bound material 1 before trimming are inputted in input areas 70a and 70b.

With the input screen 71 for the three-side trimming mode shown in FIG. 3B, widths of edge portions to be trimmed and the length and width of the bound material 1 after trimming are inputted in a plurality (in the present embodiment, five) of input areas 71a, 71b, 71c, 71d, and 71e. Moreover, the touch panel 7 switches to the input screen 72 for the corner trimming mode upon pressing of a key 71f.

With the input screen 72 for the corner trimming mode shown in FIG. 4, pairs of adjacent sides of corner portions 1e and 1f to be trimmed are inputted in a plurality (in the present embodiment, four) of input areas 72a, 72b, 72c, and 72d. The touch panel 7 with the input areas 72a, 72b, 72c, and 72d corresponds to the “second input unit” of the present invention. The corner trimming mode is turned ON upon pressing of a key 72e and OFF upon pressing of a key 72f.

The control unit 8 operatively connected to the rotation mechanism 3 so as to rotate the table 2 in such a way that the trimming line CL is positioned parallel to the longitudinal direction of the trimming blade 52, and also operatively connected to the moving mechanism 6 so as to move the trimming mechanism 5 in such a way that the trimming position is aligned with the trimming line CL.

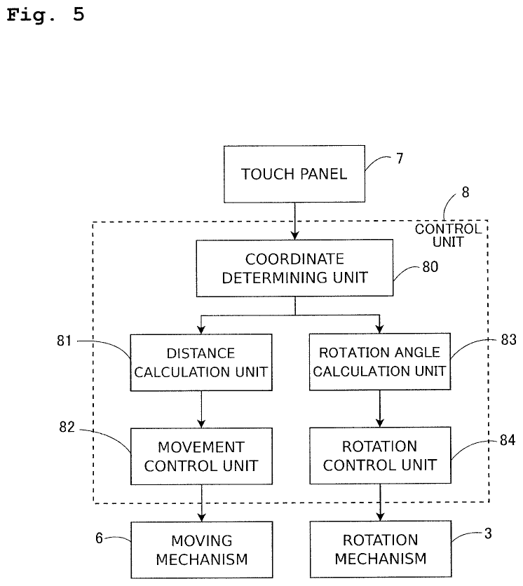

Hereinafter, the control unit 8 will be described with reference to FIGS. 5 to 8.

<Three-Side Trimming Mode>

Described first are components of the control unit 8, and the operations of each component of the control unit 8 in the three-side trimming mode. As shown in FIG. 5, the control unit 8 has a coordinate determining unit 80, a distance calculation unit 81, a movement control unit 82, a rotation angle calculation unit 83, and a rotation control unit 84.

The coordinate determining unit 80 determines coordinates of both ends of trimming lines CL1, CL2, and CL3 respectively for the top-edge portion 1a, the fore-edge portion 1b, and the bottom-edge portion 1c, on the basis of the dimensions of the bound material 1 before and after trimming inputted on the touch panel 7.

The distance calculation unit 81 calculates the distance L between the rotation center O of the bound material 1 (i.e., the rotation center of the table top 20) and the trimming line CL (the distance will simply be referred to below as the “distance L”).

The movement control unit 82 operatively connected to the moving mechanism 6 so as to move the trimming mechanism 5 such that the distance between the trimming position and the rotation center O of the bound material 1 matches the distance L calculated by the distance calculation unit 81.

The rotation angle calculation unit 83 calculates an angle by which the rotation control unit 84 rotates the table 2 (referred to below as a “rotation angle θ”), for each portion to be trimmed. In the case where only the three-side trimming mode is effected, when the trimming line CL2 is parallel to the spine 1d, and the trimming lines CL1 and CL3 are at right angles to the spine 1d, the rotation angle calculation unit 83 determines the rotation angle θ to be 90 degrees. The case where only the three-side trimming mode is effected refers to the case where the corner trimming mode is OFF resulting from the key 72e on the touch panel 7 not being pressed.

The rotation control unit 84 operatively connected to the rotation mechanism 3 so as to rotate 2 by the rotation angle θ calculated by the rotation angle calculation unit 83, for each portion to be trimmed.

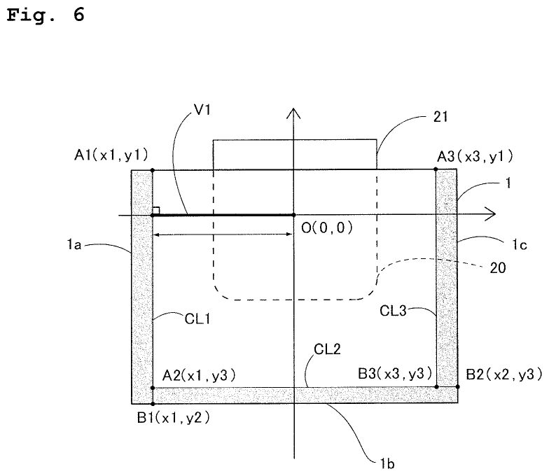

Next, a method by which the distance calculation unit 81 calculates the distance L will be described with reference to FIG. 6.

Initially, the coordinate determining unit 80 determines the coordinates A1(x1,y1) and B1(x1,y2) of both ends of the trimming line CL1 on the basis of the dimensions of the bound material 1 before and after trimming inputted on the touch panel 7. Similarly, the coordinate determining unit 80 further determines the coordinates A2(x1,y3) and B2(x2,y3) of both ends of the trimming line CL2 and the coordinates A3(x3,y1) and B3(x3,y3) of both ends of the trimming line CL3.

Next, the distance calculation unit 81 calculates the length of a perpendicular line V1 from the rotation center O to the trimming line CL1 (i.e., distance L1). Similarly, the distance calculation unit 81 further calculates the length of a perpendicular line V2 from the rotation center O to the trimming line CL2 (i.e., distance L2) and the length of a perpendicular line V3 from the rotation center O to the trimming line CL3 (i.e., distance L3).

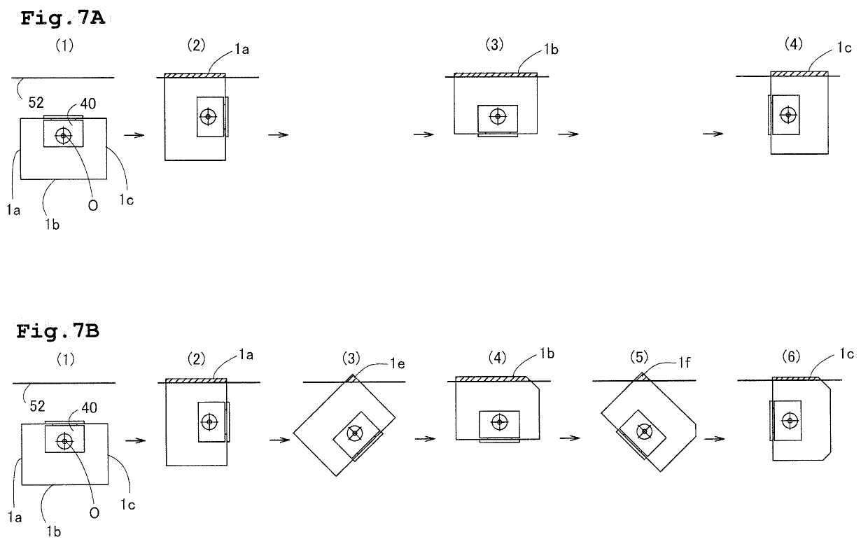

Next, the operation of each component of the trimming section in the three-side trimming mode will be described with reference to i, ii, iii, and iv in FIG. 7A.

(i) The pressing unit 4 presses and fixes the bound material 1 on the table top 20.

(ii) The rotation control unit 84 rotates the table 2 clockwise by 90 degrees.

The movement control unit 82 moves the trimming mechanism 5 such that the distance between the trimming position and the rotation center O matches the distance L1. The trimming blade 52 is moved from the non-trimming position to the trimming position and trims the top-edge portion 1a.

(iii) The rotation control unit 84 rotates the table 2 clockwise by 90 degrees. The movement control unit 82 moves the trimming mechanism 5 such that the distance between the trimming position and the rotation center O matches the distance L2. The trimming blade 52 is moved from the non-trimming position to the trimming position and trims the fore-edge portion 1b.

(iv) The rotation control unit 84 rotates the table 2 clockwise by 90 degrees. The movement control unit 82 moves the trimming mechanism 5 such that the distance between the trimming position and the rotation center O matches the distance L3. The trimming blade 52 is moved from the non-trimming position to the trimming position and trims the bottom-edge portion 1c.

<Corner Trimming Mode>

Described next are operations of each component of the control unit 8 in the corner trimming mode.

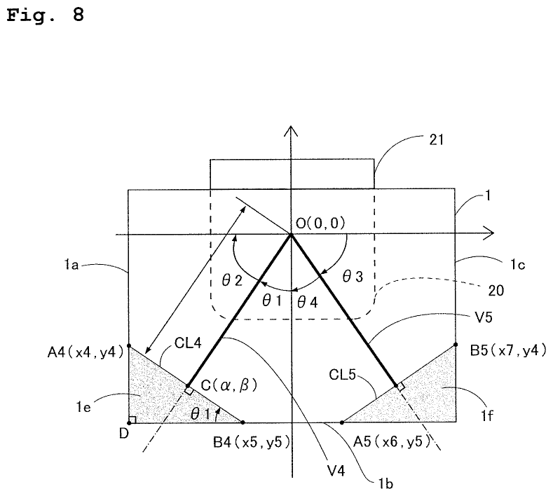

Detailed descriptions will now be given with reference to FIG. 8, regarding calculation methods performed in the corner trimming mode, one being performed by the rotation angle calculation unit 83 to calculate the rotation angle θ, the other being performed by the distance calculation unit 81 to calculate the distance L.

Initially, the coordinate determining unit 80 determines the coordinates A4(x4,y4) and B4(x5,y5) of both ends of a trimming line CL4 of the corner portion 1e and the coordinates A5(x6,y5) and B5(x7,y4) of both ends of a trimming line CL5 of the corner portion 1f, on the basis of the length and width of the bound material 1 before trimming and lengths of pairs of adjacent sides of the corner portions 1e and 1f to be trimmed, all of which are inputted on the touch panel 7.

Next, the distance calculation unit 81 performs arithmetic operations (1), (2), (3), and (4) below, considering the rotation center O to be the origin (0,0), thereby calculating the length of a perpendicular line V4 from the rotation center O to the trimming line CL4 (i.e., distance L4).

(1) A simple equation of trimming line A4-B4 is calculated with equations (1) and (2) by plugging the coordinates A4 and A5 into the linear equations:

Y₄=ax₄+b (1)

Y₅=ax₅+b (2)

(2) A simple equation of the perpendicular line V4 is calculated.

$$y = - \frac{1}{a} x \qquad ( 3 )$$

(3) Simultaneous equations of the trimming line CIA and the perpendicular line V4 are calculated, thereby obtaining the coordinates (α,β) of the intersection C of the trimming line CL4 and the perpendicular line V4.

$$β = a α + b \\ β = - \frac{1}{a} α \\ a α + \frac{1}{a} α + b = 0 \qquad ( 4 )$$

(4) The distance LA is calculated with equation (5)

L₄=\sqrt{α²+β²} (5)

The distance calculation unit 81 calculates the length of a perpendicular line V5 from the rotation center O to the trimming line CL5 (i.e., distance L5) in a similar manner.

Next, the rotation angle calculation unit 83 calculates rotation angle θ1 with equation (6) on the basis of the lengths of lines A4-D and B4-D and the angle ∠A4B4D=θ1. Then, the rotation angle calculation unit 83 calculates rotation angle θ2 with equation (7).

$$\begin{matrix}θ 1 = {tan}^{- 1} ( \frac{y 5 - y 4}{x 4 - x 5} ) & ( 6 ) \\ θ 2 = 90 - θ 1 & ( 7 )\end{matrix}$$

The rotation angle calculation unit 83 calculates rotation angles θ3 and θ4 in a similar manner.

It should be noted that the method by which the distance calculation unit 81 calculates the distance L and the method by which the rotation angle calculation unit 83 calculates the rotation angle θ are merely illustrative and not limiting.

Next, the operation of the trimming section where the three-side trimming mode and the corner trimming mode are successively effected will be described with reference to i, ii, iii, iv, v, and vi in FIG. 7B.

(i) The pressing unit 4 presses and fixes the bound material 1 on the table top 20.

(ii) The rotation control unit 84 rotates the table 2 clockwise by 90 degrees.

The movement control unit 82 moves the trimming mechanism 5 such that the distance between the trimming position and the rotation center O matches the distance L1. The trimming blade 52 is moved from the non-trimming position to the trimming position and trims the top-edge portion 1a.

(iii) The rotation control unit 84 rotates the table 2 clockwise by the rotation angle θ2. The movement control unit 82 moves the trimming mechanism 5 such that the distance between the trimming position and the rotation center O matches the distance L4. The trimming blade 52 is moved from the non-trimming position to the trimming position and trims the corner portion 1e.

(iv) The rotation control unit 84 rotates the table 2 clockwise by the rotation angle θ1. The movement control unit 82 moves the trimming mechanism 5 such that the distance between the trimming position and the rotation center O matches the distance L2. The trimming blade 52 is moved from the non-trimming position to the trimming position and trims the fore-edge portion 1b.

(v) The rotation control unit 84 rotates the table 2 clockwise by the rotation angle θ4. The movement control unit 82 moves the trimming mechanism 5 such that the distance between the trimming position and the rotation center O matches the distance L5. The trimming blade 52 is moved from the non-trimming position to the trimming position and trims the corner portion 1f.

(vi) The rotation control unit 84 rotates the table 2 clockwise by the rotation angle θ3. The movement control unit 82 moves the trimming mechanism 5 such that the distance between the trimming position and the rotation center O matches the distance L3. The trimming blade 52 is moved from the non-trimming position to the trimming position and trims the bottom-edge portion 1c.

The trimmer M according to the present invention renders it possible to form a bound material 1 superior in design and free from safety and convenience issues.

While one embodiment of the trimmer M and the trimming method according to the present invention have been described above, the present invention is not limited to the embodiment.

The moving mechanism 6 may be configured with components for moving the table 2. In such a case, the moving mechanism 6 moves the table 2 closer to or away from the trimming mechanism 5 in a direction perpendicular to the longitudinal direction of the trimming blade 52 such that the trimming line CL is aligned with the trimming position.

The input screen 72 for the corner trimming mode may have input areas in which to input the coordinates of both ends of the trimming lines CL4 and CL5, instead of the input areas 72a, 72b, 72c, and 72d. In such a case, the distance calculation unit 81 performs an arithmetic operation on the basis of the coordinates of the rotation center O and the inputted coordinates, thereby calculating the distance L between the rotation center O and the trimming line CL. Moreover, in this case, the rotation angle calculation unit 83 performs an arithmetic operation on the basis of the inputted coordinates, thereby calculating the rotation angle θ. The touch panel 7 with the input areas in which to input the coordinates of both ends of the trimming lines CL4 and CL5 corresponds to the “first input unit” of the present invention.

The input screen 72 for the corner trimming mode may have an input area in which to input the distance L. In such a case, the movement control unit 82 moves the table 2 or the trimming mechanism 5 such that the distance between the trimming position and the rotation center O matches the inputted distance L. The touch panel 7 with the input area in which to input the distance L corresponds to the “third input unit” of the present invention. Moreover, the information that is to be inputted in the input screen 72 for the corner trimming mode may be the rotation angle θ. In such a case, the rotation control unit 84 rotates the table 2 on the basis of the inputted rotation angle θ. The touch panel 7 with the input area in which to input the rotation angle θ corresponds to the “fourth input unit” of the present invention.

The input unit may be, for example, a keyboard or a mobile device. The mobile device is, for example, a smartphone or a tablet computer.

Alternatively, the input unit may be a reading unit for reading readable information such as one-dimensional and two-dimensional barcodes. In such a case, for example, the reading unit may be provided at the entrance or upstream opening of the trimming section so as to read readable information in a margin or another part of the bound material 1 and thereby obtain trimming-related information such as the dimensions of the bound material 1 before and after trimming and the coordinates of both ends of the trimming line CL.

Alternatively, the input unit may be a communication unit capable of communicating with a trimming information storage unit having the trimming-related information stored therein. In such a case, the trimming-related information is transmitted by the trimming information storage unit and is received by the communication unit through which the trimming-related information is inputted. Moreover, in this case, the trimming information storage unit may be provided in a server and the trimming-related information may be wirelessly transmitted by the server.

The corner portion to be trimmed is not limited to any corner portion that includes a corner adjacent to the fore edge. For example, a corner portion to be trimmed may be a corner portion that includes a corner adjacent to the spine 1d.

For the three-side trimming mode, the trimming lines CL1, CL2, and CL3 do not have to be parallel to the top-edge, the fore-edge, and the bottom-edge, respectively. In such a case, the distance calculation unit 81 calculates the length of the perpendicular line V from the rotation center O to the trimming line CL, i.e., the distance L, and the rotation angle calculation unit 83 calculates the rotation angle θ corresponding to the trimming line CL.

The shape and/or the size of the table 2 may be changed in accordance with the position of the trimming line CL with respect to the table 2 in such a way that the trimming is performed in a more stable state and the receiving portion 51 and the table top 20 do not contact each other. Specifically, the table 2 may be changed when the distance between an edge of the table top 20 and the trimming line CL is greater than or equal to a predetermined length and when the distance between an edge or a corner of the table top 20 and the trimming line CL is less than or equal to another predetermined length. In such a case, the trimmer M may further include a table optimization unit, which, once the coordinate determining unit 80 determines the coordinates of both ends of the trimming line CL, determines whether the table 2 needs to be changed, on the basis of the position of the trimming line CL with respect to the table top 20. When the table 2 needs to be changed, the table optimization unit causes the touch panel 7 to display a prompt to change the table 2 to an optimal table 2. The shape of the table top 20 preferably corresponds to the shape of the bound material 1 after trimming, e.g., a hexagon.

### DESCRIPTION OF REFERENCE NUMERALS

1 bound material
1a top-edge portion of the bound material
1b fore-edge portion of the bound material
1c bottom-edge portion of the bound material
1d spine of the bound material
1e, 1f corner portion of the bound material
2 table
20 table top
21 abutment portion
3 rotation mechanism
30 rotation shaft
31 bearing
32 first motor
4 pressing unit
40 pressing plate
41 pressing plate lifting unit
5 trimming mechanism
50 frame
51 receiving portion
52 trimming blade
54 drive mechanism
6 moving mechanism
60 base
61 second motor
62 feed screw
7 touch panel
8 control unit
80 coordinate determining unit
81 distance calculation unit
82 movement control unit
83 rotation angle calculation unit
84 rotation control unit
M trimmer
R transportation path
CL trimming line
O rotation center
V perpendicular line

1. A trimmer for trimming a bound material, including:
a table on which the bound material is to be placed;
a pressing unit fixing the bound material on the table;
a trimming mechanism having a trimming blade and moving the trimming blade between a trimming position and a non-trimming position so as to trim an edge portion and/or a corner portion of the bound material;
a rotation mechanism rotating the table;
a rotation control unit operatively connected to the rotation mechanism so as to rotate the table in such a way that a predetermined trimming line is positioned parallel to a longitudinal direction of the trimming blade, the predetermined trimming line being set for the edge portion and/or the corner portion of the bound material;
a moving mechanism moving the table or the trimming mechanism in a direction perpendicular to the longitudinal direction of the trimming blade; and
a movement control unit operatively connected to the moving mechanism so as to move the table or the trimming mechanism in such a way that the trimming line and the trimming position are aligned with each other.

2. The trimmer according to claim 1, wherein
the bound material is placed on the table in such a way that a predetermined rotation center of the bound material is positioned on a rotation center of the table, wherein
the trimmer further includes
a distance calculation unit calculating a distance between the trimming line and the rotation center of the bound material based on coordinates of both ends of the trimming line and coordinates of the rotation center of the bound material, and
a rotation angle calculation unit calculating a rotation angle of the table based on the coordinates of both ends of the trimming line in such a manner that the trimming line is parallel to the longitudinal direction of the trimming blade, wherein
the rotation control unit rotates the table by the rotation angle, the rotation angle being calculated by the rotation angle calculation unit, and
the movement control unit moves the table or the trimming mechanism so that a distance between the rotation center of the bound material and the trimming position matches the distance calculated by the distance calculation unit.

3. The trimmer according to claim 2, further including a first input unit receiving an input of the coordinates of both ends of the trimming line.

4. The trimmer according to claim 2, further including
a second input unit receiving an input of lengths of a pair of adjacent sides of the corner portion to be trimmed, and
a coordinate determining unit determining the coordinates of both ends of the trimming line of the corner portion to be trimmed, based on the lengths inputted to the second input unit.

5. The trimmer according to claim 1, wherein:
the bound material is placed on the table in such a way that a predetermined rotation center of the bound material is positioned on a rotation center of the table, wherein
the trimmer further includes
a third input unit receiving an input of a rotation angle of the table in such a manner that the trimming line is parallel to the longitudinal direction of the trimming blade, and
a fourth input unit receiving an input of a distance between the rotation center of the bound material and the trimming position, wherein the rotation control unit rotates the table by the rotation angle, the rotation angle being inputted to the third input unit, and
the movement control unit moves the table or the trimming mechanism so that the distance between the rotation center of the bound material and the trimming position matches the distance inputted to the fourth input unit.

6. A method for trimming a bound material, including:
(a) providing a trimmer for trimming the bound material; the trimmer including
a table on which the bound material is placed,
a pressing unit fixing the bound material on the table,
a trimming mechanism having a trimming blade and moving the trimming blade between a trimming position and a non-trimming position so as to trim the bound material along a trimming line of the bound material,
a rotation mechanism rotating the table,
a moving mechanism moving the table or the trimming mechanism in a direction perpendicular to a longitudinal direction of the trimming blade,
a rotation control unit operatively connected to the rotation mechanism, and
a movement control unit operatively connected to the moving mechanism;
(b) setting the trimming line for an edge portion and/or a corner portion of the bound material;
(c) fixing the bound material on the table;
(d) rotating the table in such a way that the trimming line is positioned parallel to the longitudinal direction of the trimming blade;
(e) moving the table or the trimming mechanism so as to align the trimming line and the trimming position with each other; and
(f) trimming the edge portion and/or the corner portion of the bound material along the trimming line.

7. The method according to claim 6, wherein
the trimmer further includes a rotation angle calculation unit calculating a rotation angle of the table, wherein
the method further includes
(g) fixing the bound material on the table so as to position a predetermined rotation center of the bound material on a rotation center of the table, in step (c),
(h) calculating the rotation angle of the table based on coordinates of both ends of the trimming line in such a way that the trimming line is parallel to the longitudinal direction of the trimming blade, after step (a) and before step (d), and
(i) rotating the table by the calculated rotation angle, in step (d).

8. The method according to claim 7, wherein
the trimmer further includes a first input unit receiving an input of the coordinates of both ends of the trimming line, wherein
the method further includes
(j) inputting the coordinates of both ends of the trimming line, after step (a) and before step (h).

9. The method according to claim 8, wherein
the trimmer further includes
a second input unit receiving an input of lengths of a pair of adjacent sides of the corner portion to be trimmed, and
a coordinate determining unit determining the coordinates of both ends of the trimming line of the corner portion to be trimmed, wherein
the method further includes
(k) inputting lengths of the pair of adjacent sides of the corner portion to be trimmed, after step (a) and before step (h), and
(l) determining the coordinates of both ends of the trimming line of the corner portion to be trimmed, based on the inputted lengths of the pair of adjacent sides of the corner portion, after step (a) and before step (h).

10. The method according to claim 6, wherein
the trimmer further includes a distance calculation unit calculating a distance between the trimming line and a predetermined rotation center of the bound material, wherein
the method further includes
(m) fixing the bound material on the table so as to position the predetermined rotation center of the bound material on a rotation center of the table, in step (C),
(n) calculating the distance between the trimming line and the predetermined rotation center of the bound material based on coordinates of both ends of the trimming line and coordinates of the predetermined rotation center of the bound material after step (a) and before step (e), and
(o) moving the table or the trimming mechanism so that the distance between the predetermined rotation center of the bound material and the trimming position matches the calculated distance, in step (e).

11. The method according to claim 10, wherein
the trimmer further includes a first input unit receiving an input of the coordinates of both ends of the trimming line, wherein
the method further includes
(p) inputting the coordinates of both ends of the trimming line after step (a) and before step (n).

12. The method according to claim 11, wherein
the trimmer further includes
a second input unit receiving an input of lengths of a pair of adjacent sides of the corner portion to be trimmed, and
a coordinate determining unit determining the coordinates of both ends of the trimming line of the corner portion to be trimmed, wherein
the method further includes
(q) inputting of lengths of the pair of adjacent sides of the corner portion to be trimmed, after step (a) and before step (n), and
(r) determining the coordinates of both ends of the trimming line of the corner portion to be trimmed, based on inputted lengths of the pair of adjacent sides of the corner portion, after step (a) and before step (n).

13. The method according to claim 6, wherein
the trimmer further includes a third input unit receiving an input of a rotation angle of the table, wherein
the method further includes
(s) fixing the bound material on the table so as to position a predetermined rotation center of the bound material on a rotation center of the table, in step (C),
(t) inputting the rotation angle of the table in such a way that the trimming line is parallel to the longitudinal direction of the trimming blade, after step (a) and before step (d), and
(u) rotating the table by the inputted rotation angle, in step (d).

14. The method according to claim 6, wherein
the trimmer further includes a fourth input unit receiving an input of a distance between a predetermined rotation center of the bound material and the trimming position, wherein,
the method further includes
(v) fixing the bound material on the table so as to position the predetermined rotation center of the bound material on a rotation center of the table, in step (C),
(w) inputting the distance between the predetermined rotation center of the bound material and the trimming position, after step (a) and before step (e), and
(x) moving the table or the trimming mechanism so that the distance between the predetermined rotation center of the bound material and the trimming position matches the inputted distance, in step (e).
